(19) United States
(12) Patent Application Publication
(10) Pub. No.: US 2016/0217466 A1
(43) Pub. Date: Jul. 28, 2016

(54) DIRECT FUNDS TRANSFER PROCESS

(71) Applicant: KATE J. KENNEDY, Roseville, CA (US)

(72) Inventor: KATE J. KENNEDY, Roseville, CA (US)

(21) Appl. No.: 15/007,046

(22) Filed: Jan. 26, 2016

Related U.S. Application Data
(60) Provisional application No. 62/107,727, filed on Jan. 26, 2015.

(51) Int. Cl. G06Q 20/40

(52) U.S. Cl. CPC G06Q 20/401

(57) ABSTRACT

The present disclosure relates generally to settlement processing. More particularly, techniques (e.g., systems, methods, and devices) are disclosed for facilitating direct settlement of transactions for a specific transacting entity. Techniques are disclosed to enable reporting of transacting entity-specific settlement information to further enhance the settlement process. In certain embodiments, a processing system may perform direct settlement with a transacting entity for transactions involving the transacting entity. The transactions may be identified using a unique identifier assigned to the transacting entity associated with those transactions. During settlement, the processing system can directly communicate with a financial institution of the transacting entity, as opposed to an acquirer, to facilitate settlement of the transactions that are identified as being associated with the transacting entity.

### RELATED APPLICATIONS

This application claims the benefit of and priority to U.S. Provisional Application No. 62/107,727, filed Jan. 26, 2015, the entire content of which is incorporated herein by reference in its entirety for all purposes.

### BACKGROUND

Some processing systems may provide processing services such as those designed to facilitate authorization of transactions, and clearing and settlement of those transactions. An acquirer may handle processing for hundreds, if not thousands of transacting entities (e.g. merchants), each of which may have hundreds or thousands of transactions to settle with the acquirer.

An acquirer may be challenged with the task of sorting through thousands of records to identify transactions involving a particular transacting entity to perform clearing and settlement processes with respect transactions involving that transacting entity. For such an acquirer, processing time and computing resources required to determine settlement of a transaction may be impacted by a volume of transactions that have been processed for settlement. As a result, the efficiency for settlement of transactions associated with a transacting entity may be impacted.

Embodiments of the invention address these and other problems, individually and collectively.

### SUMMARY

The present disclosure relates generally to identifying transactions associated with a given transacting entity and settlement processing of the identified transactions. More particularly, techniques (e.g., systems, methods, and devices) are disclosed for assigning a unique identifier to a transacting entity to identify transactions associated with the transacting entity, and facilitating direct settlement of transactions for that transacting entity. Techniques are disclosed to enable reporting of transacting entity-specific settlement information to further enhance the settlement process.

Embodiments provide a method performed by a computer system (e.g. a processing system). The computer system may store a plurality of identifiers associated with a set of transacting entities registered with a central network. An identifier identifies a transacting entity in the set of transacting entities. The computer system may receive an authorization request message for a transaction initiated by an account holder at the transacting entity. The method may also include determining that the transacting entity is included in the set of transacting entities. The computer system may receive an authorization response message from an authorizing computer for the authorization request message. The method may further include sending, to an acquirer computer with the transacting entity, the authorization response message including the identifier identifying the transacting entity. The computer system may initiate a settlement process with a financial institution computer associated with the transacting entity for the transaction based on determining that the transacting entity is included in the set of transacting entities.

In some embodiments, the method may also include receiving a settlement message including the identifier identifying the transacting entity. The computer system may identify a plurality of transactions associated with the transacting entity based on the identifier, the plurality of transactions including the transaction initiated by the account holder at the transacting entity. The method may also include retrieving settlement preferences of the transacting entity from a repository; and initiating the settlement process directly with the financial institution computer associated with the transacting entity for the plurality of transactions based on the settlement preferences of the transacting entity.

Embodiments provide a method performed by an acquirer computer system. The method includes receiving, at an acquirer computer system, information associated with a transaction initiated by an account holder at a first transacting entity. The information includes a first identifier associated with the first transacting entity. The method also includes generating, by the acquirer computer system, an authorization request message to request authorization for processing the transaction. The authorization request message includes the first identifier identifying the first transacting entity. The acquirer computer system sends the authorization request message to a processing system. The acquirer computer receives an authorization response message in response to the authorization request message. The authorization response message approves or declines the processing of the transaction. The method also includes sending, by the acquirer computer system, a clearing message to the processing system. The acquirer computer system receives a settlement report from the processing system. The settlement report includes a first set of transactions grouped together based on the first identifier associated with the first transacting entity and a second set of transactions grouped together based on a second identifier associated with a second transacting entity. The method further includes settling, by the acquirer computer system, the first set of transactions with a financial institution computer associated with the first transacting entity.

Embodiments may also provide a system including one or more processors; and a non-transitory computer readable storage medium communicatively coupled with the one or more processors. The readable storage medium comprises code, executable by the one or more processors, to implement the above-described methods.

The foregoing, together with other features and embodiments will become more apparent upon referring to the following specification, claims, and accompanying drawings.

### BRIEF DESCRIPTION OF THE DRAWINGS

FIG. 1 shows a block diagram of a transaction processing environment that uses transacting entity-specific information according to some embodiments of the invention.

FIG. 2 shows a diagram of a transaction processing environment for single message processing for a transaction.

FIG. 3 shows a diagram of a transaction processing environment for dual message processing for a transaction.

FIG. 4 shows a block diagram of a transaction processing environment for facilitating direct settlement of transacting entity-specific transactions according to some embodiments of the invention.

FIG. 5 shows a diagram of a transaction processing environment for facilitating direct settlement of transacting entity-specific transactions using dual message processing according to some embodiments of the invention.

FIG. 6 shows a diagram of a transaction processing environment for transacting entity-specific settlement reporting using dual message processing according to some embodiments of the invention.

FIG. 7 shows a diagram of a transaction processing environment for facilitating direct settlement of transacting entity-specific transactions using single message processing according to some embodiments of the invention.

FIG. 8 shows a diagram of a transaction processing environment for transacting entity-specific settlement reporting using single message processing according to some embodiments of the invention.

FIG. 9 shows a flowchart of steps illustrating a transacting entity-specific direct settlement according to some embodiments of the invention.

FIG. 10 is a block diagram of a computer apparatus that may be used to implement embodiments disclosed herein, according to an embodiment of the invention.

### DETAILED DESCRIPTION

In the following description, for the purposes of explanation, specific details are set forth in order to provide a thorough understanding of embodiments of the invention. However, it will be apparent that various embodiments may be practiced without these specific details. For example, circuits, systems, algorithms, structures, techniques, networks, processes, and other components may be shown as components in block diagram form in order not to obscure the embodiments in unnecessary detail.

It is to be understood that embodiments of the invention may include more or fewer than the components shown individually in a diagram. The figures and description are not intended to be restrictive.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The present disclosure relates generally to identification of transactions associated with a specific transacting entity and settlement processing of the identified transactions. More particularly, techniques (e.g., systems, methods, and devices) are disclosed for assigning a unique identifier (e.g. merchant identifier) to a transacting entity (e.g. a merchant) to identify transactions associated with the transacting entity, and facilitating direct settlement of transactions for that transacting entity. Techniques are disclosed to enable reporting of transacting entity-specific settlement information to further enhance the settlement process.

In certain embodiments, a processing system may perform direct settlement with a transacting entity for transactions involving the transacting entity. The transactions involving a transacting entity may be identified based on information about a transacting entity (e.g., a unique identifier assigned to the transacting entity) associated with those transactions. An acquirer may associate the identifier of the transacting entity with transactions involving that transacting entity. A clearing message sent from the acquirer to the processing system for a transaction associated with the transacting entity may include the identifier. During settlement, the processing system can directly communicate with a financial institution associated with the transacting entity, as opposed to communicating with the acquirer, to facilitate direct settlement of the transactions that are identified as being associated with the transacting entity. Accordingly, embodiments provide for direct settlement of the transactions with the financial institution associated with the transacting entity. That is, the processing system may initiate the transfer of the funds owed to the transacting entity in connection with the transactions.

In various embodiments, the acquirer computer system may send a clearing message to the processing system. The clearing message may include information for a plurality of transactions associated with a plurality of transacting entities. One or more of the transactions in the clearing message may be linked to an identifier of the transacting entity associated with the one or more transactions. The processing system may generate a settlement report based on the clearing message. For example, the transacting entity-specific settlement report may include a first set of transactions grouped together based on a first identifier associated with a first transacting entity and a second set of transactions grouped together based on a second identifier associated with a second transacting entity. Thus, upon receiving the transacting entity-specific settlement report, the acquirer computer system may proceed to settle the first set of transactions with the first transacting entity and settle the second set of transactions with the second transacting entity without having to process the transacting entity-specific settlement report to identify the transactions associated with the first transacting entity (e.g. the first set of transactions). Accordingly, embodiments improve the effective use of the computing resources of the acquirer computer system.

In certain embodiments, the processing system may manage a repository. The repository may include an entry associated with a transacting entity to store information about the transacting entity. The transacting entity or the repository entry associated with the transacting entity may be identified by a unique identifier. The information may include bank account information, acquirer information, and/or settlement preferences of the transacting entity. The processing system may access the repository to verify the identifier of a transacting entity and/or retrieve the settlement preferences of the transacting entity to determine a manner for facilitating direct settlement including the financial institution with which to communicate for direct settlement. In some embodiments, the processing system can generate transacting entity-specific settlement reports that can be provided to an acquirer to assist the acquirer with the clearing and settlement process.

Before discussing specific embodiments and examples, some descriptions of terms used herein are provided below.

A “central server” or a “server computer” may typically be a powerful computer or cluster of computers. For example, the server computer can be a large mainframe, a minicomputer cluster, or a group of servers functioning as a unit. In one example, a server computer may be a database server coupled to a Web server. Data transfer and other communications between components such as computers may occur via any suitable wired or wireless network, such as the Internet or private networks. The server computer may be associated with an entity such as a transacting entity, an acquirer, a database (e.g. an information database, an application database, an entertainment database), an transaction processing entity or an authorizing entity.

An “account holder” may holds an account. An “account holder” may include an individual or an entity that uses a system. An account holder may be associated with one or more accounts and/or user devices. In some cases, the account holder may also be referred to as a user or a consumer.

An “authorizing entity” (e.g. an issuer) can include an entity that authorizes a request. In some embodiments, an authorizing entity is an issuer that issues an account. The account (which may be associated with one or more user devices) may refer to any suitable account including payment accounts (e.g. a credit card account, a checking account, a savings account, a merchant account assigned to a consumer, a prepaid account, etc.), an employment account, an online account (e.g. email account, database subscription account, etc.).

A “transacting party” is an entity that conducts a transaction. It can be an entity that engages in transactions and can sell goods or services, or provides access to goods or services. For example, a transacting party may include a merchant.

An “acquirer” is typically a business entity (e.g., a commercial bank) that has a business relationship with a particular transacting party or other entity. Some entities can perform both issuer and acquirer functions. Some embodiments may encompass such single entity issuer-acquirers.

A “processing system” may refer to a computer that processes transactions. In some embodiments, the processing system can be in an electronic system used to accept, transmit, or process transactions made by user devices for money, goods, or services. The transaction processing server computer may transfer information and funds among issuers, acquirers, transacting parties, and users. An example of the transaction processing server computer may include a payment processing server computer such as VisaNet™, operated by Visa®. Payment processing server computers such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services.

“Clearing” may refer to a process that occurs between a time that a commitment is made for a transaction until settlement. In some embodiments, clearing may include exchanging financial details between an acquirer and an authorizing computer to facilitate posting to the account holder's account and reconciliation of the consumer's settlement position. Specifically, during the clearing process, final transaction data is delivered from an acquirer to an authorizing computer for posting to the account holder's account, the calculation of certain fees and charges that apply to the authorizing entity and acquirer involved in the transaction, and the conversion of transaction amounts to appropriate settlement currencies.

“Settlement” may refer to an exchange of value to facilitate an obligation. In some embodiments, a settlement process of calculating, determining, reporting and transferring the net financial position of the authorizing entities and acquirers for all transactions that are cleared.

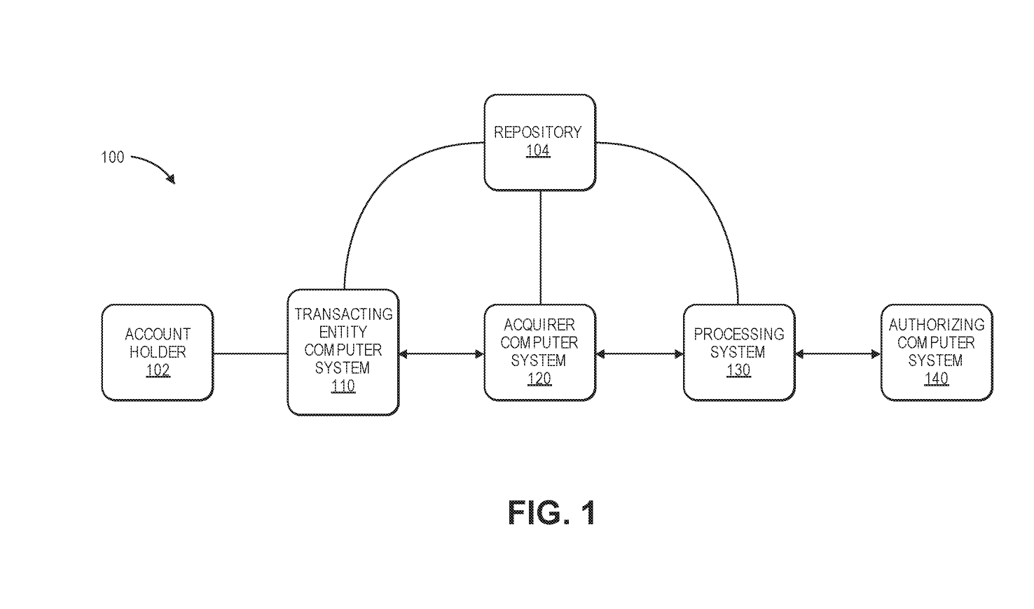

FIG. 1 illustrates a transaction processing environment 100 that manages transacting entity-specific information according to some embodiments of the present invention. FIG. 1 illustrates functional elements of a transaction processing environment according to one embodiment of the present invention. It is to be understood that embodiments of the invention may include more than one of the components shown individually in FIG. 1. Additionally, some embodiments of the invention may include fewer than all of the components shown in FIG. 1.

Transaction processing environment 100 may include an account holder 102, a transacting entity computer system 110 associated with a transacting entity (e.g. a merchant), an acquirer computer system 120 associated with an acquirer, a processing system 130 associated with a transaction processing entity, and an authorizing computer system 140 associated with an authorizing entity. The various computer systems may be configured to communicate in any suitable manner using any suitable communication network. Although the entities are shown as coupled to particular entities, the entities may be configured to communicate through any other suitable interfaces and some entities may be removed and/or added to the system depending on the configuration of the system.

The processing system 130 can include data processing subsystems, networks, and operations used to support and deliver authorization services, exception file services, and clearing and settlement services. For example, processing system 130 can comprise a server computer and databases of information. In some embodiments, the processing system 130 can be implemented as a payment processing network. An exemplary payment processing network may include, for example, VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Processing system 130 can use any suitable wired or wireless network, including the Internet. Among other functions, processing network 130 may be responsible for ensuring that a user is authorized to conduct a transaction (via an authentication process), confirm the identity of a party to a transaction (e.g., via receipt of a personal identification number), confirm a sufficient balance or credit line to permit a purchase, or reconcile the amount of a purchase with the consumer's account (via entering a record of the transaction amount, date, etc.).

In some embodiments, transaction processing environment 100 may include one or more data sources implemented as a repository 104 (e.g., “Global Merchant Repository” or “GMR”). Repository 104 may be embodied by one or more database server computers that may store information (“merchant information”) about one or more transacting entities, each associated with a transacting entity computer system, e.g., transacting entity computer system 110. A unique identifier may be associated with each transacting entity identified in the repository 104. The repository 104 may store a plurality of entries, each corresponding to a different transacting entity. An entry may be identified by the identifier associated with (or assigned to) a transacting entity and may store information associated with the transacting entity. For example, the information may include preferences of the transacting entity, including preferences for settlement processes (e.g., whether the transacting entity requests or supports direct settlement). The stored information may also include an identifier for a financial institution associated with the transacting entity and bank account information associated with the transacting entity held at the financial institution. Information associated with the transacting entity may be provided by a transacting entity computer system 110 associated with the transacting entity. The repository 104 may be managed by the processing system 130 of a transaction processing entity, any other computer system in FIG. 1, or another computer system associated with a third party.

In some embodiments, the information associated with the transacting entity may be obtained from the transacting entity computer system 110 of the transacting entity for registration in a program (e.g., a Digital Commerce Program) offered by a central network (e.g. processing system 130). A unique identifier may be assigned to the transacting entity when the transacting entity is registered in the program. The registration may include validating the transacting entity based on criteria for the program. The criteria may be related to transaction history of the transacting entity or other criteria related to business of the transacting entity. Registering in the program may indicate that the transacting entity is a verified entity (e.g. the entity is verified and/or authenticated by the central network). In some embodiments, benefits such as faster processing of transaction request may be offered to the transacting entities registered in the program.

In some embodiments, the information associated with the transacting entity may include acquirer information about one or more acquirers used by the transacting entity for transaction processing. The acquirer information may identify an acquirer including information about an account of an acquirer and/or acquirer computer systems for transaction processing.

In some embodiments, the repository 104 may be accessible by any of the entities identified in FIG. 1. The repository 104 may be accessible to those transacting entities and/or acquirers participating in a service or a program provided and/or supported by the processing system 130 that uses the repository 104. As provided above, a unique identifier may be assigned to a transacting entity may be and associated with processing of a transaction at any stage of processing, such as authorization, and/or clearing and settlement. The unique identifier and any other information associated with the transacting entity may be stored at the repository 104. For example, the repository 104 may store analytical information about the transactions associated with a transacting entity. Authorization of a transaction may be determined for a specific transacting entity based on the analytical information about previous transactions involving that transacting entity.

In an exemplary transaction, the account holder 102 may interact with the transacting entity computer system 110 directly, or may interact with the transacting entity computer system 110 using a computing device to initiate a transaction. For example, the transaction may be for the purchase of a good or a service. The transaction may be initiated when the account holder 102 presents his or her payment device to the transacting entity computer system 110 as payment for goods or services. The transacting entity computer system 110 may determine a payment account and other data based on the payment device. The transacting entity computer system 110 transmits information about the account holder's account and transaction amount in an authorization request message to the acquirer computer system 120. In some embodiments, the transmitted information may include a unique identifier assigned to the transacting entity. The identifier may be assigned to the transacting entity by a processing system 130 and may be stored at the repository 104 along with additional information associated with the transacting entity.

Acquirer computer system 120 may receive information associated with a transaction (e.g. transaction amount, description of the goods or services included in the transaction, account information of the account holder, identifier associated with transacting entity, etc.) from the transacting entity computer system 110. The acquirer computer system 120 may generate an authorization request message and transmit the authorization request message to the processing system 130. The authorization request message may include information about the account holder, such as one or more of an account identifier (e.g. an account number), an expiration date, a currency code; information about the transaction, such as the transaction amount, a transaction stamp of the transacting entity, the acceptor city, the acceptor state/country, etc; and information about the transacting entity such as the identifier of the transacting entity.

An authorization request message may be protected using a secure encryption method (e.g., 128-bit SSL or equivalent) in order to prevent data from being compromised. In one embodiment, the authorization request message is a standardized interchange message such as an International Organization for Standardization (ISO) 8583 message. An ISO 8583 message includes a message type indicator; one or more bitmaps indicating which data elements are present in the message, and data elements of the message. The authorization request message may comprise routing information as part of or in addition to the interchange message. As part of generating the authorization request message, the transacting entity computer system 110 may communicate with a database which stores data such as data regarding the account owner, the payment device, or the account owner's transaction history with the merchant.

As provided above, in some embodiments, the transacting entity may know the identifier assigned to them and include the identifier in the transaction information sent to the acquirer computer system 120. If the transaction information does not include the transacting entity identifier, the acquirer computer system 120 may insert the identifier in the authorization request message generated by the acquirer computer system 120. The transacting entity identifier may be used by the processing system 130 to identify transactions associated with the transacting entity.

Processing system 130 may receive the authorization request message and may determine an authorizing entity capable of authorizing transactions initiated using the account of the account holder 102. For example, the authorizing entity may be the issuer of the account of the account holder 102. The processing system 130 may then forward the authorization request message to the authorizing computer system 140 for authorization of the transaction. Any number of additional processes including fraud analysis, authentication, risk analysis, and/or other actions may be performed by the processing system 130 (or any of the other computers associated with the authorization request message). In some embodiments, the processing system 130 may verify the transacting entity associated with the identifier provided in the authorization request. Processing system 130 may store information about the transaction in association with the identifier. For example, the information may be stored at the repository 104. This may be used later for direct settlement.

The authorizing computer system 140 receives the authorization request message and determines whether the transaction should be authorized. The authorizing computer system 140 may determine the account associated with the authorization request message, compare an account value or credit available in the account to the transaction amount, perform any number of fraud checks or risk analysis processes, and/or perform any other relevant actions to determine an appropriate authorization decision.

The authorizing computer system 140 may determine an authorization decision approving or declining the transaction and may generate an authorization response message including the authorization decision. In some embodiments, the authorizing computer system 140 may generate the authorization response message based on determining that the transacting entity is included in the set of transacting entities whose information is stored in the repository 104. This may indicate that the transacting entity is registered in the program offered by the processing system 130 and thus, the transacting entity is trusted and/o previously verified by the processing system 130. The authorizing computer system 140 may send the authorization response message to the processing system 130 for completion and processing of the transaction.

The processing system 130 may receive the authorization response message, log the authorization decision for settlement and clearance purposes, and send the authorization response message to acquirer computer system 120 for reporting to the transacting entity computer system 110. In some embodiments, the authorization decision may be stored in association with the identifier for the transacting entity involved in the transaction. The decision may be used later to facilitate direct settlement with a financial institution associated with the transacting entity.

Acquirer computer system 120 receives the authorization response message and forwards the authorization response message to the transacting entity computer system 110 for completion of the transaction. Acquirer computer system 120 may log the authorization decision and/or perform any other functions related to the transaction.

The transacting entity computer system 110 receives the authorization response message and completes the transaction based on the authorization decision of the authorization response message. For example, the transacting entity may provide a good or service to the account holder 102 if the authorization response message includes an indication of an accepted transaction and may decline to provide a good or service to the account holder 102 if the authorization response message includes an indication of a declined transaction.

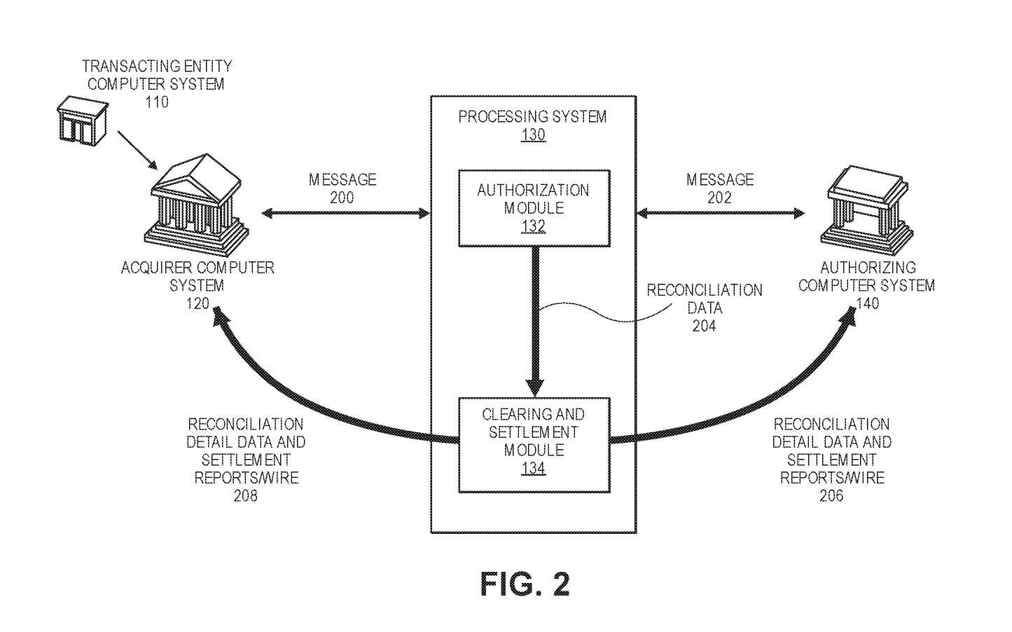

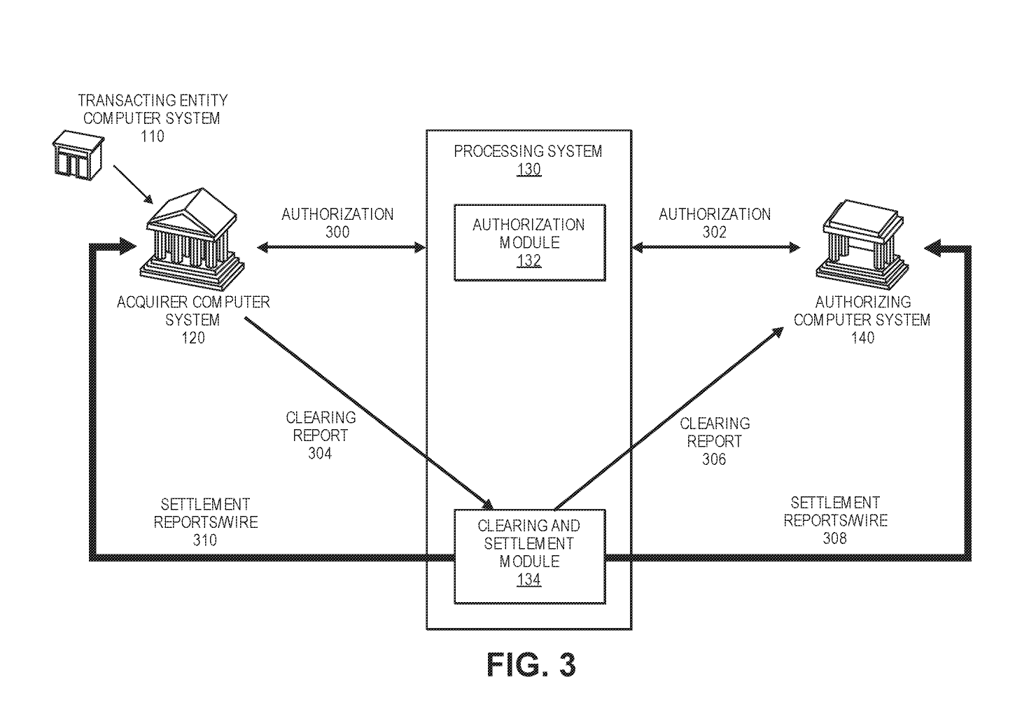

The processing system 130 may facilitate the clearing and the settlement process. Clearing and settlement may occur periodically, such as at the end of a day. In some embodiments, clearing and settlement can occur simultaneously. Clearing and settlement for a transaction can be performed based on whether a transaction is processed as a single message transaction (discussed in greater detail in connection with FIG. 2) or as a dual message transaction (discussed in greater detail in connection with FIG. 3). The choice of processing method may vary depending upon the issuer, the type of card, and/or the region in which a transaction takes place.

As illustrated in FIG. 2, for a single message transaction, the acquirer computer system 120 submits a single electronic message 200 containing all data required for the authorization, clearing and settlement of a transaction initiated at the transacting entity computer system 110. The message 200 may include the authorization request along with additional data required for clearing and settlement. Clearing occurs at the time of the authorization for single message transactions.

In the embodiment illustrated in FIG. 2, authorization, and clearing and settlement are both performed by the processing system 130. The processing system 130 may include an authorization module 132 that may interact with the authorizing computer system 140 to authorize the transaction. For example, the authorization module 132 may exchange one or more messages 202 such as an authorization request message and an authorization response message with the authorizing computer system 140 to authorize the transaction. The processing system 130 may also include a clearing and settlement module 134. The authorization module 132 may send reconciliation data 204 to the clearing and settlement module 134 after the authorization process of the transaction is complete (e.g. after the transaction has been approved or declined). The clearing and settlement module 134 may interact with the authorizing computer system 140 to perform the clearing and settlement for the transaction. For example, the clearing and settlement module 134 may send reconciliation detail data and settlement reports 206 to the authorizing computer system 140. The clearing and settlement module 134 may also send reconciliation detail data and settlement reports 208 to the acquirer computer system 120.

As illustrated in FIG. 3, for or a dual message transaction, acquirer computer system 120 submits an electronic message 300 at the time of purchase containing the information required for an authorization decision. The processing system 130 may include an authorization module 132 that may interact with the authorizing computer system 140 to authorize the transaction. For example, the authorization module 132 may exchange one or more messages 302 such as an authorization request message and an authorization response message with the authorizing computer system 140 to authorize the transaction. Actual clearing and settlement occurs at a later time. A second message (e.g., a clearing message) is sent by acquirer computer system 120 at a later point in time containing additional data required for clearing and settlement. For example, acquirer computer system 120 may send a clearing report 304 containing a batch of all transactions reported by the acquirer computer system 120. The clearing report 304 may be received at a clearing and settlement module 134 of the processing system 130. The clearing and settlement module 134 of the processing system 130 may perform clearing and settlement based on the transactions identified by acquirer computer system 120. Settlement may occur on each business day and is conducted on a net basis for all transactions submitted during the previous settlement cycle.

In FIG. 3, authorization and clearing and settlement are both performed by the processing system 130. For clearing and settlement, the clearing and settlement module 134 may provide, over a communication wire, settlement reports 310 to acquirer computer system 120. The clearing and settlement module 134 may also provide, over a communication wire, settlement reports 308 to the authorizing computer system 140.

In either of dual message processing or single message processing, the processing system 130 may provide, over a communication wire, settlement reports to the acquirer computer system 120 and/or the authorizing computer system 140. Settlement reports may provide information related to settlement processing including a daily explanation to the parties about demands and accounting of demands for settlement of transactions. A settlement report may include the following:
Face value of settlement after consideration of interchange fees;
Client-to-client fees—fees by acquirer and issuer for exchanging transactions;
Daily payment charges from a consumer to the payment processor; and
A summary of settlement including a net balance for parties account after settlement.

The following steps describe examples of clearing and settlement described generally with respect to FIG. 1. For clearing, the transacting entity computer system 110 transmits sales draft information for a transaction, including account numbers and transaction amounts, to the acquirer computer system 120. The acquirer computer system 120 or a third-party processor in communication with the acquirer computer system 120 may generate a clearing message (otherwise referred to as “a clearing draft”) that includes information obtained from the sales draft information for a transaction. The acquirer computer system 120 may transmit the clearing message to the processing system 130.

In many instances, a single acquirer computer system, e.g., the acquirer computer system 120, may be designated to handle processing for several transacting entities. As a result, the acquirer computer system 120 may handle processing of thousands of transactions for clearing. To perform clearing for a particular transacting entity, acquirer computer system 120 may have to perform additional processing of transactions to identify the transactions associated with that particular transacting entity.

The processing system 130 routes the clearing message to the authorizing entity by transmitting the clearing message to authorizing computer system 140. Based on the clearing message and the transaction data, the processing system 130 computes the settlement obligation of the authorizing entity and the amount due to the acquirer. The obligation is determined based on consideration of the net applicable fees and charges owed to the processing system, the acquirer and the issuer. The processing system 130 requests payment from the authorizing computer system 140 for the computed settlement obligation.

Based on the settlement obligation, the authorizing computer system 140 transfers funds to a financial institution designated for settlement for the transacting entity by the transaction processor (e.g. the processing entity 130). The authorizing computer system 140 sends a statement to the account holder 102 and collects payment, in the case of a credit or deferred debit card, or collects payment directly from the account holder's 102 deposit account, in the case of a debit card.

At the direction of the processing system 130, the financial institution designated by the transaction processor transfers funds to an account of the acquirer associated with the acquirer computer system 120. The acquirer computer system 120 credits the account of the transacting entity for the amount of the transaction less any fees the acquirer charges in accordance with the contractual agreement between the merchant and the acquirer.

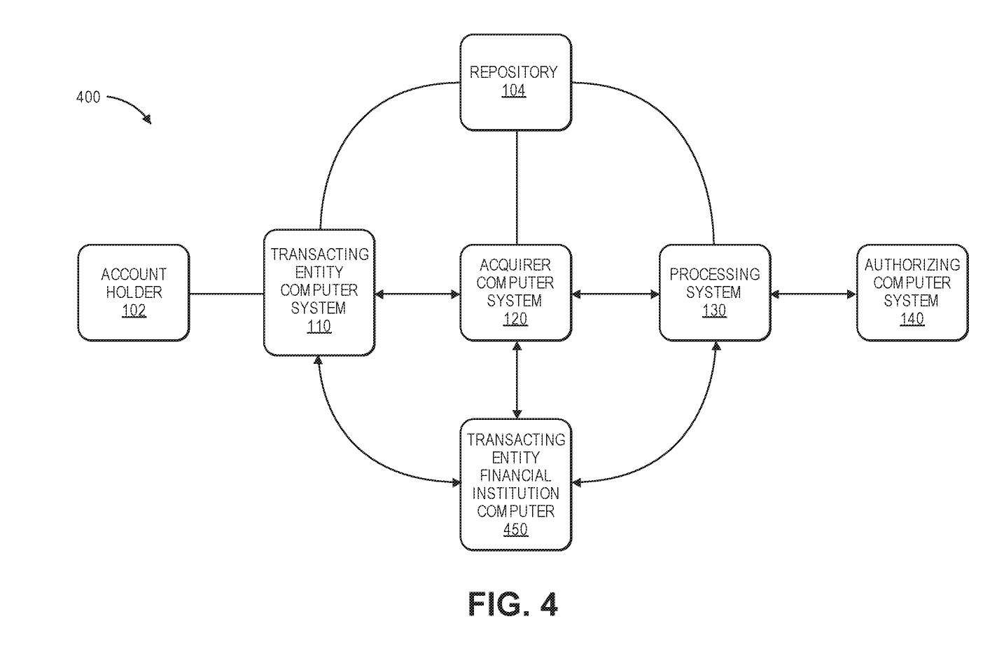

As discussed above, the unique identifiers associated with transacting entities may be used for direct settlement of transactions. Direct settlement may refer to identification of the transactions associated with a given transacting entity and transferring funds associated with the identified transactions directly to a financial institution associated with (e.g. selected by) that transacting entity. Now turning to FIG. 4, a block diagram of a transaction processing environment 400 is shown for facilitating direct settlement of transacting entity-specific transactions according to some embodiments of the invention. FIG. 4 includes elements described with reference to FIGS. 1-3. These elements are identified using the same reference numerals and the description of these elements is provided above.

As explained above, a transacting entity associated with a transacting entity computer system 120 may provide information to the repository 104 to register the transacting entity as a verified (e.g. trusted) transacting entity for transacting entity—specific transaction processing. With respect to settlement, the transacting entity computer system 110 can provide information to the repository 104 to indicate preferences of the transacting entity for settlement. For example, the preferences may indicate that the transacting entity prefers direct settlement with a given financial institution. That is, the transacting entity prefers to have the funds associated with the transactions conducted by the transacting entity to be directly deposited an account of the transacting entity at the identified financial institution.

The acquirer computer system 120 can identify a transaction it has associated with an identifier of a transacting entity involved in that transaction. Therefore, during the clearing process, the acquirer computer system 120 can identify the transactions associated with a particular transacting entity, regardless of single message or dual message processing of transactions. The acquirer computer system 120 can indicate an identifier of the transacting entity in a message (e.g., an authorization message for single message processing or a clearing message for dual message processing) communicated to the processing system 130.

The processing system 130 can identify those transactions associated the transacting entity based on the identifier associated with the transacting entity. The processing system 130 can verify the transacting entity based on the identifier indicated in a message received from the acquirer computer system 120. Upon verifying a transacting entity in the repository 104, the processing system 130 can ensure that direct settlement occurs with a financial institution identified by the transacting entity. Thus, the identifier enables the processing system to ensure accuracy for direct settlement with a transacting entity.

For clearing and settlement, the processing system 130 can obtain information from the repository 104 to determine whether a specific transacting entity has indicated a preference for direct settlement. The information may be stored at the repository 104 in form of a data structure. The processing system may examine the data structure stored at the repository 104 to determine preferences including financial institution information for direct settlement with a transacting entity.

Referring back to FIG. 4, direct settlement performed by the processing system 130 will be described next. The settlement processes described above as being performed for an acquirer can alternatively be performed by the processing system 130 for a particular merchant (e.g. for transactions associated with that particular merchant). In some embodiments, at the direction of the processing system 130, the financial institution designated by the processing system 130 can directly transfer funds corresponding to a settlement obligation to a financial institution computer 450 that manages an account for a merchant. The financial institution computer 450 can credit the account of the transacting entity for the amount of the transaction less any fees charged by the financial institution in accordance with the contractual agreement between the transacting entity and the financial institution. In some embodiments, although transacting entity-specific transactions have been identified, the processing system 130 can communicate with the acquirer computer system 120 to facilitate settlement with respect to settlement obligations for a particular transacting entity. Alternatively or additionally, the financial institution computer 450 may send information to the acquirer computer system 120 indicating the results of direct settlement performed between the financial institution computer 450 and the processing system 130.

Direct settlement improves efficiency in the settlement process by reducing processing performed to identify transactions (among a large number of transactions performed by a number of transacting entities) for a particular transacting entity during settlement. The use of a unique identifier for a transacting entity may reduce processing for the acquirer computer system 120 to identify transactions associated with that transacting entity for clearing and settlement processing with respect to that transacting entity. The acquirer computer system 120 may perform less processing for direct settlement because the processing system 130 can determine settlement obligations with respect to transactions associated with the transacting entity based on the unique identifier assigned to the transacting entity. Accordingly, direct settlement allows the acquirer computer and/or the processing system to improve use of their respective computing resources (e.g. less computing resources and potentially less communications between the acquirer computer system, the processing system and/or the authorizing computer system will be required for the clearing and settlement processing).

The improvements in settlement processing enables transacting entities to receive payment for settlement faster than existing settlement processes. Existing settlement processes involve communication with the acquirer computer system to process payment for settlement obligations. With direct settlement, an account of the transacting entity may be credited directly without involvement of an acquirer, thereby enabling the transacting entity to receive payment sooner for settlement.

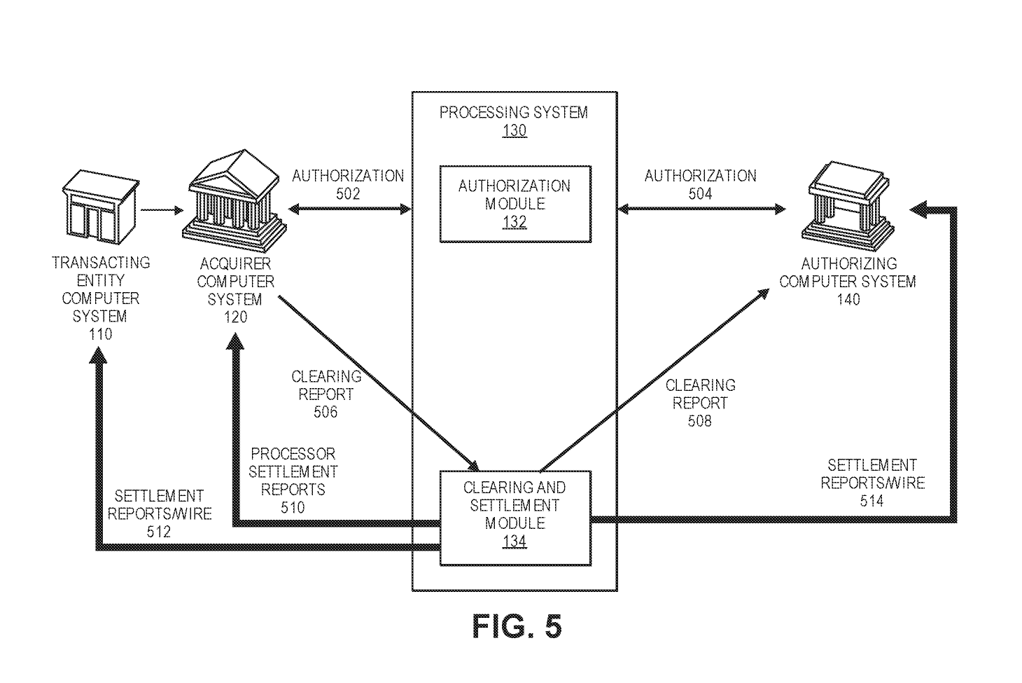

Now referring to FIG. 5, a diagram is shown of an exemplary transaction processing environment for facilitating direct settlement of transacting entity-specific transactions according to some embodiments of the invention. The embodiment shown in FIG. 5 may be implemented in a dual message transaction processing environment. For example, the embodiment shown in FIG. 5 may be implemented using the transaction processing environment of FIG. 4.

The acquirer computer system 120 submits an electronic message 502 at the time of purchase containing the information required for an authorization decision. The processing system 130 may include an authorization module 132 that may interact with the authorizing computer system 140 to authorize the transaction. For example, the authorization module 132 may exchange one or more messages 504 with the authorizing computer system 140 (e.g. sends an authorization request message to the authorizing computer system 140 and receives an authorization response message from the authorizing computer system 140) to authorize the transaction. Actual clearing and settlement occurs at a later time when a clearing message (e.g. clearing report 506) containing additional data required for clearing and settlement is sent by the acquirer computer system 120. For example, the clearing report 506 may include a batch of all transactions reported by the acquirer computer system 120. The clearing report 506 may be received at a clearing and settlement module 134 of the processing system 130. The clearing and settlement module 134 of the processing system 130 may perform clearing and settlement based on the transactions identified by acquirer computer system 120. Settlement may occur on each business day and is conducted on a net basis for all transactions submitted during the previous settlement cycle.

As provided above, the processing system 130 may perform authorization processing through the authorization module 132, and clearing and settlement processing through the clearing and settlement module 134. The processing system 130 may facilitate direct settlement processing with a financial institution of the transacting entity other than a financial institution associated with the acquirer.

In some embodiments, during authorization processing, the processing system 130 can store information about transactions (e.g., authorization decisions) associated with a transacting entity based on a unique identifier associated with the transacting entity. During the clearing and settlement processing, the processing system 130 can identify those transactions involving the transacting entity using the unique identifier. Upon identifying the transactions associated with the transacting entity, the processing system 130 can perform direct settlement for those identified transactions if the transacting entity has indicated financial institution for direct settlement.

In some embodiments, the processing system 130 can generate transacting entity-specific settlement reports 512 based on the transactions identified during clearing. For example, the processing system 130 can generate transacting entity-specific settlement reports 112 for settlement processing performed for transactions associated with the unique identifier associated with the transacting entity provided in the clearing message (e.g. clearing report 506). The processing system 130 can also generate transacting entity-specific settlement reports 514 for transmission to the authorizing computer system 140. The transacting entity-specific settlement reports 514 may be a copy of the transacting entity-specific settlement reports 512 or the transacting entity-specific settlement reports 514 may be generated based on the transactions identified during clearing. Similarly, using the information identifying the acquirer involved in the transactions, a transacting entity-specific settlement report 510 about transacting entity-specific settlement obligations can be generated for the acquirer. The transacting entity-specific settlement report 510 may be provided to acquirer computer system 120. The transacting entity-specific settlement report 510 may include all transactions associated with the transacting entity identified using the identifier associated with that transacting entity. Accordingly, in the embodiment illustrated in FIG. 5, even though settlement of transactions associated with the transacting entity are settled with the financial institution of the transacting entity, the acquirer computer system 120 and/or the authorizing computer system 140 are also informed about the settlement details by receiving the settlement reports 510 and/or 514, respectively, from the processing system 130.

The transacting entity-specific settlement report 510 sent to the acquirer computer system 120 from the processing system 130 identifies all transactions associated with a given transacting entity using the unique identifier of that transacting entity. The embodiments eliminate the processing by the acquirer computer system 120 to analyze the settlement reports 510 to identify all transactions associated with a given transacting entity (as done in the conventional systems).

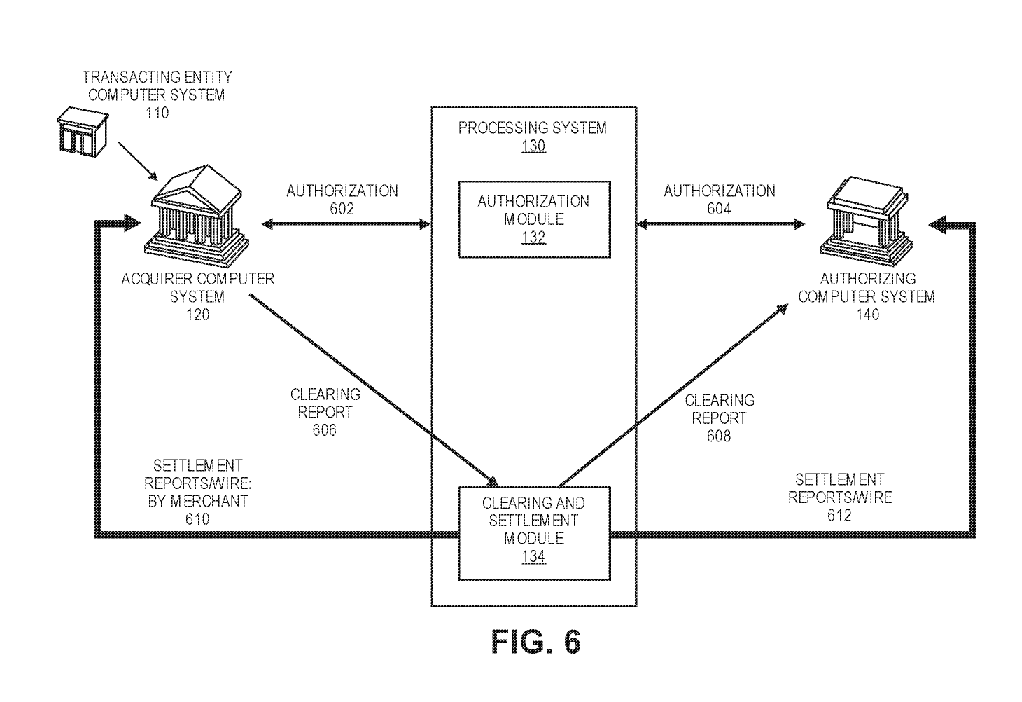

In some embodiments, the processing system may not send the funds directly to the financial institution of the transacting entity (e.g. may not perform direct settlement). However, the processing entity may send a settlement report to the acquirer that identifies all transactions associated with the transacting entity so that the acquirer can directly settle with the transacting entity without further processing. Specifically, the settlement report sent to the acquirer may include all transactions processed by the acquirer (e.g. transactions associated with a plurality of transacting entities) grouped into batches such that each batch includes transactions associated with a single transacting entity identified using the identifier associated with that transacting entity. FIG. 6 illustrates such an embodiment where the transacting entity-specific settlement report is sent to the acquirer for faster and more efficient settlement.

FIG. 6 shows a diagram of a transaction processing environment for transacting entity-specific settlement reporting according to some embodiments of the invention. The embodiment shown in FIG. 6 may be implemented in a dual message transaction processing environment. For example, the embodiment shown in FIG. 6 may be implemented using the transaction processing environment of FIG. 4.

The processing system 130 illustrated in FIG. 6 may perform authorization processing through the authorization module 132, and clearing and settlement processing through the clearing and settlement module 134.

In connection with authorization processing, the processing system 130 receives an electronic message 602 from the acquirer computer system 120. The electronic message 602 includes the information required for an authorization decision. The processing system 130 may include an authorization module 132 that may interact with the authorizing computer system 140 to authorize the transaction. For example, the authorization module 132 may exchange one or more messages 604 with the authorizing computer system 140 (e.g. sends an authorization request message to the authorizing computer system 140 and receives an authorization response message from the authorizing computer system 140) to authorize the transaction.

In connection with clearing and settlement processing, actual clearing and settlement occurs at a later time when a clearing message (e.g. clearing report 606) containing additional data required for clearing and settlement is sent by the acquirer computer system 120. For example, the clearing report 606 may include a batch of all transactions reported by the acquirer computer system 120. The clearing report 606 may be received at a clearing and settlement module 134 of the processing system 130. The clearing and settlement module 134 of the processing system 130 may perform clearing and settlement based on the transactions identified by acquirer computer system 120. Settlement may occur on each business day and is conducted on a net basis for all transactions submitted during the previous settlement cycle.

In some embodiments, during authorization processing, the processing system 130 can store information about transactions (e.g., authorization decisions) associated with a transacting entity based on a unique identifier associated with the transacting entity. During the clearing and settlement processing, the processing system 130 can identify those transactions involving the transacting entity using the unique identifier. Upon identifying the transactions associated with the transacting entity, the processing system 130 can generate transacting entity-specific settlement reports 610 based on the transactions identified during clearing.

Payment processing system 130 can enhance settlement processing for an acquirer by providing transacting entity-specific settlement reports 610 to acquirer computer system 120. Acquirers may be burdened with records for transactions processed for several transacting entities. As a result, acquirers may have to perform additional and computation-extensive processing to identify settlement information associated with a specific transacting entity. The transacting entity-specific settlement reports 610 may reduce processing time for the acquirer to verify settlement with respect to each particular transacting entity whose transactions go through that acquirer. The transacting entity-specific settlement reports 610 enable the acquirer computer system 120 to reduce processing time for settlement by being tailored toward the settlement obligations indicated with respect to a specific transacting entity. Accordingly, the acquirer computer system 120 may not have to process and sort data to determine settlement obligations for a specific transacting entity.

Using preferences indicated by a transacting entity, the processing system 130 can further reduce processing during settlement by enabling a transacting entity to configure settlement with respect to a particular acquirer. Those transactions identified during clearing as associated with a transacting entity identifier can be further processed to determine the acquirer for the transactions. Based on the transactions for a particular acquirer, payment processing system 130 can determine settlement obligations for the transacting entity with respect to that acquirer. These settlement obligations can be provided to the specific acquirer to facilitate faster processing of settlement with respect to the specific transacting entity.

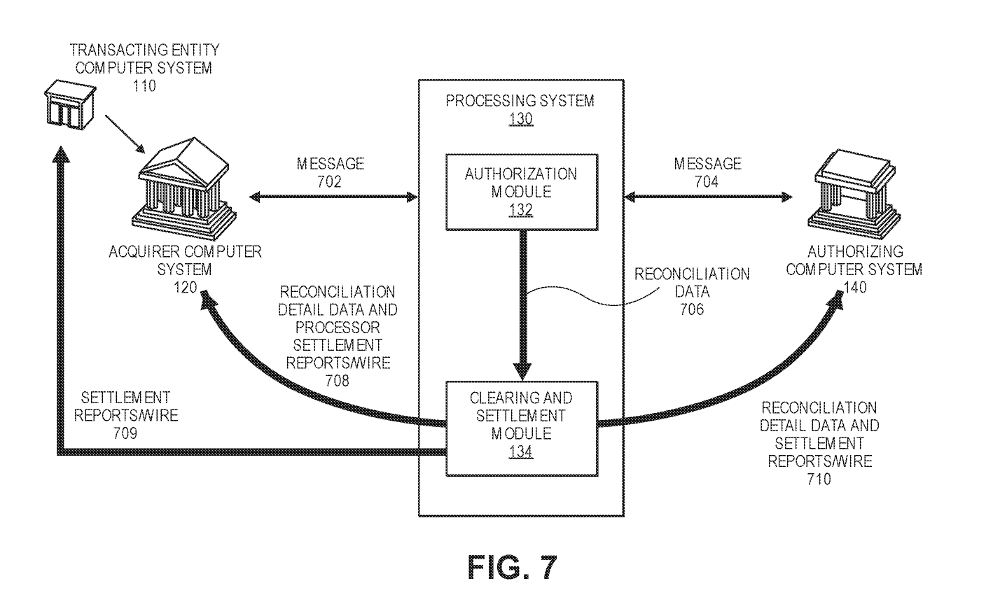

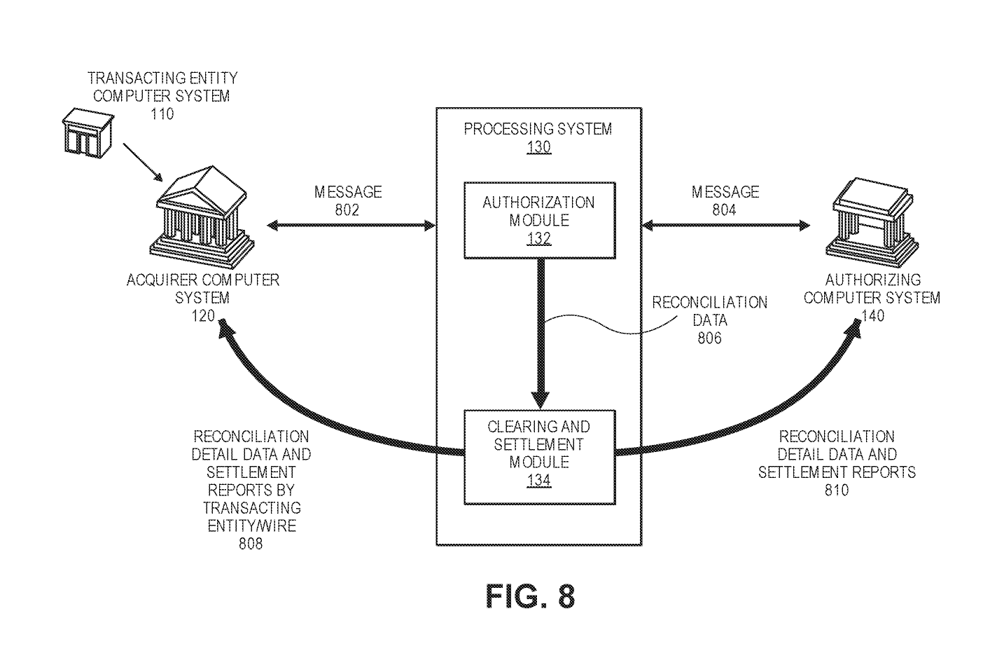

FIGS. 7 and 8 show diagrams of transaction processing environments for facilitating direct settlement and transacting entity-specific settlement reporting according to some embodiments of the present invention. The examples shown in FIGS. 7 and 8 are implemented in a single message transaction processing environment. Thus, the transaction processing environments illustrated in FIGS. 7 and 8 may be seen as counterparts of the transaction processing environments illustrated in FIGS. 5 and 6, respectively, using single message processing. These transactions processing systems may be implemented in transaction processing environment of FIG. 4.

FIG. 7 illustrates the processing system 130 facilitating direct settlement processing with a financial institution associated with a transacting entity other than one associated with an acquirer. Direct settlement may include sending one or more transacting entity-specific settlement reports indicating transacting entity-specific settlement obligations to a financial institution associated with the transacting entity, such as financial institution computer 450. This embodiment is similar to the embodiment discussed above in connection with FIG. 5 in that settlement reports for a specific transacting entity are sent directly to the financial institution of the transacting entity for settlement. The transacting entity is associated with a different financial institution than the acquirer. This embodiment is different from the embodiment illustrated in FIG. 5 in that clearing and settlement occur after authorization during single transaction message processing.

In the embodiment illustrated in FIG. 7, the acquirer computer system 120 submits a single electronic message 702 containing all data required for the authorization, clearing and settlement of a transaction initiated at the transacting entity computer system 110. The message 702 may include the authorization request along with additional data required for clearing and settlement. For example, the message 702 may include a unique identifier assigned to the transacting entity by, for example, the processing system 130. When the processing system 130 receives the authorization message, the processing system 130 can identify a transaction associated with a specific transacting entity. The processing system 130 may verify the merchant identifier in the repository 104 to determine whether the identifier is associated with the transacting entity corresponding to the transaction.

Clearing occurs at the time of the authorization for single message transactions. The processing system 130 may include an authorization module 132 that may interact with the authorizing computer system 140 to authorize the transaction. For example, the authorization module 132 may exchange one or more messages 704 such as an authorization request message and an authorization response message with the authorizing computer system 140 to authorize the transaction.

The processing system 130 may also include a clearing and settlement module 134. The authorization module 132 may send reconciliation data 706 to the clearing and settlement module 134 after the authorization process of the transaction is complete (e.g. after the transaction has been approved or declined). The clearing and settlement module 134 may interact with the authorizing computer system 140 to perform the clearing and settlement for the transaction. For example, the clearing and settlement module 134 may send reconciliation detail data and settlement reports 710 to the authorizing computer system 140. The clearing and settlement module 134 may also send reconciliation detail data and settlement reports 708 to the acquirer computer system 120.

The processing system 130 may determine settlement preferences for the transacting entity. For example, the processing system 130 may retrieve the settlement preferences for the transacting entity from the repository 104. When the settlement preferences indicate direct settlement, the processing system 130 can generate settlement reports 709 for the merchant based on those transactions including the current transaction associated with the identifier of the transacting entity. The transacting entity-specific settlement reports 709 may be sent to a financial institution of the transacting entity, e.g., financial institution computer 450. The processing system 130 may also generate settlement reports specific to an acquirer 708 for transactions processed for the transacting entity associated with the identifier. Those settlement obligations associated with the identifier for the acquirer can be included in the settlement reports 708 sent to the acquirer.

FIG. 8 shows payment processing system 130 generating transacting entity-specific settlement reporting according to some embodiments of the invention. The transaction processing environment shown in FIG. 8 is similar to FIG. 6 except that transacting entity-specific settlement reporting is implemented in a single message transaction processing environment. As explained with respect to FIG. 7, payment processing system 130 may be able to determine transactions associated with a transacting entity based on a unique identifier indicated in authorization requests from the acquirer.

In the embodiment illustrated in FIG. 8, the acquirer computer system 120 submits a single electronic message 802 containing all data required for the authorization, clearing and settlement of a transaction initiated at the transacting entity computer system 110. The message 802 may include the authorization request along with additional data required for clearing and settlement. For example, the message 802 may include a unique identifier assigned to the transacting entity by, for example, the processing system 130. When the processing system 130 receives the authorization message, the processing system 130 can identify a transaction associated with a specific transacting entity. The processing system 130 may verify the merchant identifier in the repository 104 to determine whether the identifier is associated with the transacting entity corresponding to the transaction.

Clearing occurs at the time of the authorization for single message transactions. The processing system 130 may include an authorization module 132 that may interact with the authorizing computer system 140 to authorize the transaction. For example, the authorization module 132 may exchange one or more messages 804 such as an authorization request message and an authorization response message with the authorizing computer system 140 to authorize the transaction.

The processing system 130 may also include a clearing and settlement module 134. The authorization module 132 may send reconciliation data 806 to the clearing and settlement module 134 after the authorization process of the transaction is complete (e.g. after the transaction has been approved or declined). The clearing and settlement module 134 may interact with the authorizing computer system 140 to perform the clearing and settlement for the transaction. For example, the clearing and settlement module 134 may send reconciliation detail data and settlement reports 810 to the authorizing computer system 140. The clearing and settlement module 134 may also send reconciliation detail data and settlement reports 808 to the acquirer computer system 120.

The processing system 130 may generate settlement reports 808 for transactions processed by acquirer computer system 120 that are associated with a specific transacting entity based on the unique identifier. The processing system 130 can determine settlement obligations for transactions handled by the acquirer with respect to the specific transacting entity. The transacting entity-specific settlement reports 808 enables the acquirer to reduce processing time for determining settlement obligations because the acquirer can avoid sorting through settlement records associated with a plurality of transacting entities to determine settlement for a particular transacting entity.

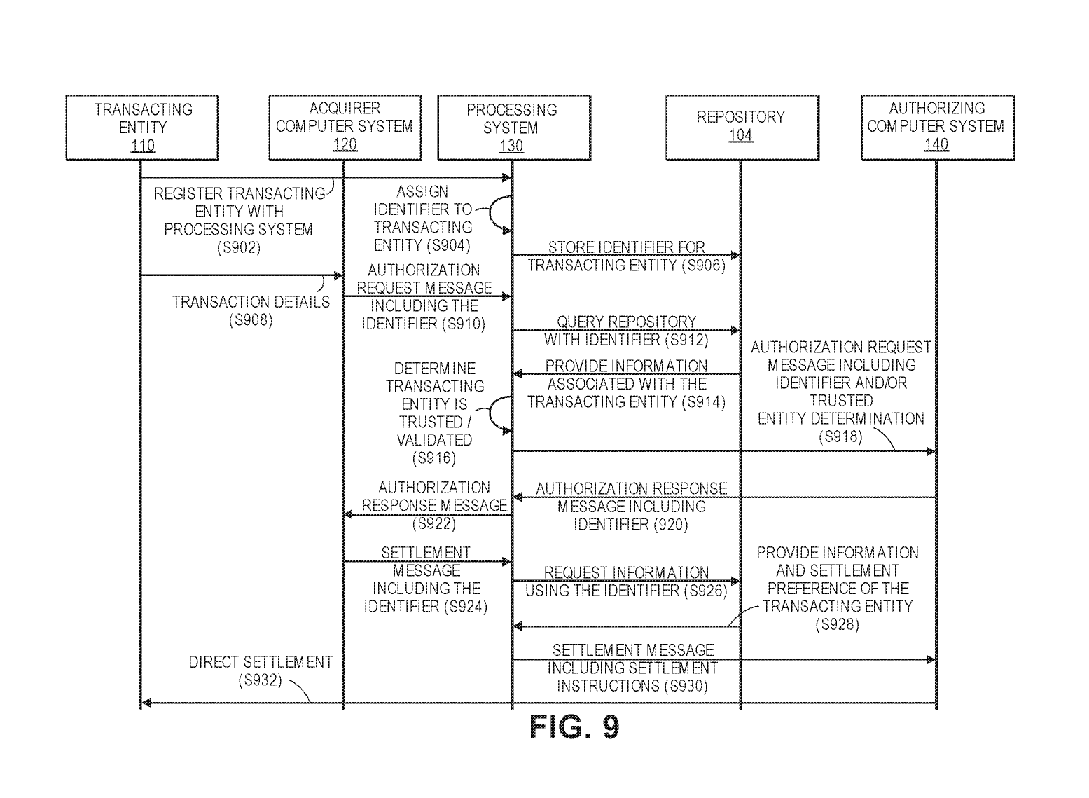

FIG. 9 illustrates a flowchart of steps illustrating a transacting entity-specific direct settlement according to some embodiments of the invention. The steps illustrated in FIG. 9 may be associated with registration (steps S902-S906), authorization (steps S908-S922), and clearing and settlement (steps S924-S932).

At step S902, the transacting entity 110 may register with the processing system 130 to participate in a program established by the processing system 130. Upon registration, at step S904, the processing system 130 may assign a unique identifier to the transacting entity 110. The processing system 130 may store the unique identifier along with any additional information associated with the transacting entity at a repository 104 (step S906). For example, the repository 104 may store a plurality of entries. Each entry may correspond to a different transacting entity. Each entry may store information associated with the transacting entity and each entry may be identifiable or retrievable using the unique identifier assigned to the transacting entity.

At a later point in time, at step S908, the transacting entity may send transaction details to the acquirer computer system 120 associated with the transacting entity 110. The transaction details may include information related to the transaction, such as a transaction amount, description of the good or service being purchased, etc. as well information related to the transacting entity 110, such as the name, address and/or the unique identifier associated with the transacting entity 110.

At step S910, the acquirer computer system 120 may generate a transaction authorization request message which includes the unique identifier associated with the transacting entity 110. The acquirer computer system 120 may send the transaction authorization request message to the processing system 130. In other embodiments, the transacting entity 110 may generate and send the authorization request message with the unique identifier associated with the transacting entity.

At step S912, upon receiving the transaction authorization request message, the processing system 130 may query the repository 104 using the identifier provided in the transaction authorization request message. If there is an entry in the repository 104 corresponding to the identifier, the processing system 130 may retrieve, from the repository 104, information associated with the transacting entity using the identifier (step S914). In addition, if there is an entry in the repository 104 corresponding to the identifier, the processing system 130 may determine that the transacting entity is a trusted entity who has been previously verified and approved (step S916).

At step 918, the processing system 130 may send a transaction authorization request message to the authorizing computer system 140. The transaction authorization request message may include the unique identifier of the transacting entity 110 as well as the determination that the transacting entity 110 is a trusted and/or validated entity.

The authorizing computer system 140 may process the transaction authorization request message and generate a transaction authorization response message either approving or denying the transaction request. At step S920, the authorizing computer system 140 sends the transaction authorization response message to the processing system 130. At step S922, the processing system 130 may transmit the transaction authorization response message to the acquirer computer system 120.

At a later point in time, clearing and settlement processing may take place. At step S924, the acquirer computer system 120 may send a settlement message to the processing system 130. The settlement message may include or may be generated using the unique identifier assigned to the transacting entity 110. At step S926, the processing system 130 may retrieve information associated with the transacting entity 110 from the repository 140 using the unique identifier assigned to the transacting entity 110. At step S928, the processing system 130 may receive information associated with the transacting entity 110 including the settlement preferences of the transacting entity 110 from the repository 104.

At step S930, the processing system 130 may send a settlement message to the authorizing computer system 130 with settlement instructions generated based on the settlement preferences of the transacting entity 110. At step S932, the authorizing computer system 140 may directly settle with the transacting entity 110 by directly sending, to a financial institution associated with the transacting entity 110 other than the acquirer, funds owed to the transacting entity 110 as a result of the one or more transactions associated with the transacting entity 110.

Embodiments use a unique identifier assigned to a transacting entity to identify transactions associated with the transacting entity. Once the transactions are identified at the processing system, the processing system can directly settle with the transacting entity by sending funds owed to the transacting entity to a financial institution identified by the transacting entity. Alternatively, the processing system may generate a report and group together all transactions associated with the transacting entity. This eliminates the burden of identifying transactions associated with a particular transacting entity at the acquirer, improving these of the computing resources by the acquirer.

The various participants and elements described herein with reference to FIGS. 1-9 may operate one or more computer apparatuses to facilitate the functions described herein. Any of the elements in FIGS. 1-9, including any servers or databases, may use any suitable number of subsystems to facilitate the functions described herein.

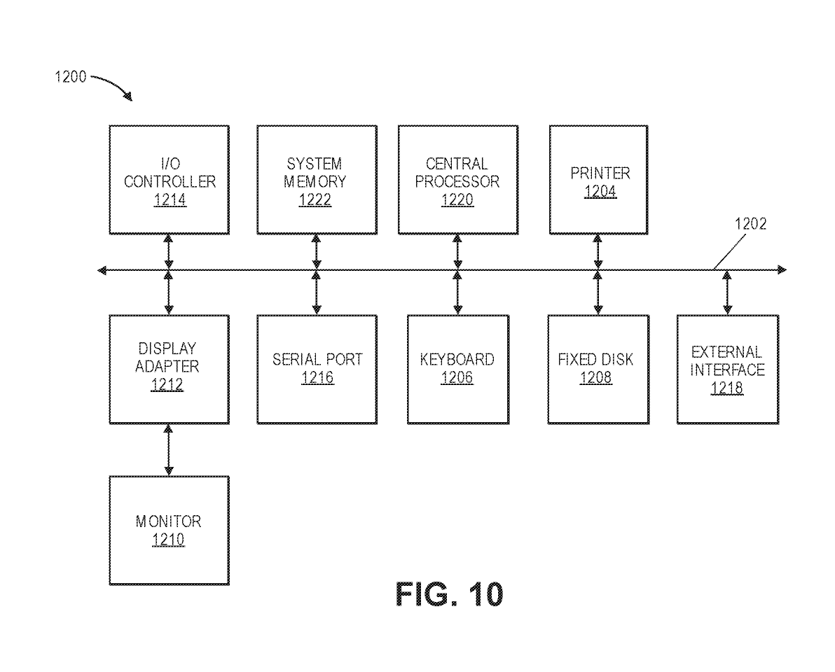

Examples of such subsystems or components are shown in FIG. 10. The subsystems shown in FIG. 12 are interconnected via a system bus 1202. Additional subsystems such as a printer 1204, keyboard 1206, fixed disk 1208 (or other memory comprising computer readable media), monitor 1210, which is coupled to display adapter 1212, and others are shown. Peripherals and input/output (I/O) devices, which couple to I/O controller 1215 (which can be a processor or other suitable controller), can be connected to the computer system by any number of means known in the art, such as serial port 1216. For example, serial port 1216 or external interface 1218 can be used to connect the computer apparatus to a wide area network such as the Internet, a mouse input device, or a scanner. The interconnection via system bus allows the central processor 1220 to communicate with each subsystem and to control the execution of instructions from system memory 1222 or the fixed disk 1208, as well as the exchange of information between subsystems. The system memory 1222 and/or the fixed disk 1208 may embody a computer readable medium.

Embodiments of the invention are not limited to the above-described embodiments. For example, although separate functional blocks are shown for an issuer, payment processing network, and acquirer, some entities perform all of these functions and may be included in embodiments of invention.

Specific details regarding some of the above-described aspects are provided above. The specific details of the specific aspects may be combined in any suitable manner without departing from the spirit and scope of embodiments of the invention. For example, back end processing, data analysis, data collection, and other transactions may all be combined in some embodiments of the invention. However, other embodiments of the invention may be directed to specific embodiments relating to each individual aspect, or specific combinations of these individual aspects.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
storing, by a computer system, a plurality of identifiers associated with a set of transacting entities registered with a central network, wherein an identifier identifies a transacting entity in the set of transacting entities;
receiving an authorization request message for a transaction initiated by an account holder at the transacting entity;
determining that the transacting entity is included in the set of transacting entities;
receiving an authorization response message from an authorizing computer for the authorization request message;
sending, to an acquirer computer with the transacting entity, the authorization response message including the identifier identifying the transacting entity; and
initiating a settlement process with a financial institution computer associated with the transacting entity for the transaction based on determining that the transacting entity is included in the set of transacting entities.

2. The method of claim 1, wherein the authorization request message includes the identifier associated with the transacting entity.

3. The method of claim 1, wherein the authorization response message is generated by the authorizing computer based on determining that the transacting entity is included in the set of transacting entities.

4. The method of claim 1, further comprising:
determining that the transacting entity is a verified entity based on determining that the transacting entity is included in the set of transacting entities.

5. The method of claim, further comprising:
upon determining that the transacting entity is included in the set of transacting entities, retrieving information associated with the transacting entity from a repository.

6. The method of claim 5, wherein the information includes settlement preferences of the transacting entity.

7. The method of claim 6, further comprising:
implementing the settlement process based on the settlement preferences of the transacting entity.

8. The method of claim 1, further comprising:
registering the set of transacting entities with the central network, wherein registering includes validating the set of transacting entities based on a transaction history of each transacting entity.

9. The method of claim 1, further comprising, prior to initiating the settlement process:
receiving a settlement message including the identifier identifying the transacting entity;
identifying a plurality of transactions associated with the transacting entity based on the identifier, the plurality of transactions including the transaction initiated by the account holder at the transacting entity;
retrieving settlement preferences of the transacting entity from a repository; and
initiating the settlement process directly with the financial institution computer associated with the transacting entity for the plurality of transactions based on the settlement preferences of the transacting entity.

10. The method of claim 9, wherein the settlement message is included in the authorization request message.

11. The method of claim 9, wherein the settlement message is separate from the authorization request message.

12. A server computer, comprising:
one or more processors; and
a non-transitory computer readable storage medium communicatively coupled with the one or more processors and storing instructions which, when executed by the one or more processors, cause the server computer to:
store a plurality of identifiers associated with a set of transacting entities registered with a central network, wherein an identifier identifies a transacting entity in the set of transacting entities;
receive an authorization request message for a transaction initiated by an account holder at the transacting entity;
determine that the transacting entity is included in the set of transacting entities;
receive an authorization response message from an authorizing computer for the authorization request message;
send, to an acquirer computer with the transacting entity, the authorization response message including the identifier identifying the transacting entity; and
initiate a settlement process with a financial institution computer associated with the transacting entity for the transaction based on determining that the transacting entity is included in the set of transacting entities.

13. The server computer of claim 12, wherein the authorization response message is generated by the authorizing computer based on determining that the transacting entity is included in the set of transacting entities.

14. The server computer of claim 12, wherein the instructions, when executed by the one or more processors, further cause the server computer to:
determine that the transacting entity is a verified entity based on determining that the transacting entity is included in the set of transacting entities.

15. The server computer of claim 12, wherein the instructions, when executed by the one or more processors, further cause the server computer to:
upon determining that the transacting entity is included in the set of transacting entities, retrieve information including settlement preferences associated with the transacting entity from a repository; and
implement the settlement process based on the settlement preferences of the transacting entity.

16. The server computer of claim 12, wherein the instructions, when executed by the one or more processors, further cause the server computer to:
register the set of transacting entities with the central network, wherein registering includes validating the set of transacting entities based on a transaction history of each transacting entity.

17. The server computer of claim 12, wherein the instructions, when executed by the one or more processors, further cause the server computer to:
receive a settlement message including the identifier identifying the transacting entity;
identify a plurality of transactions associated with the transacting entity based on the identifier, the plurality of transactions including the transaction initiated by the account holder at the transacting entity;
retrieve settlement preferences of the transacting entity from a repository;
and
initiate the settlement process directly with the financial institution computer associated with the transacting entity for the plurality of transactions based on the settlement preferences of the transacting entity.

18. A method comprising:
receiving, at an acquirer computer system, information associated with a transaction initiated by an account holder at a first transacting entity, wherein the information includes a first identifier associated with the first transacting entity;
generating, by the acquirer computer system, an authorization request message to request authorization for processing the transaction, wherein the authorization request message includes the first identifier identifying the first transacting entity;
sending, by the acquirer computer system to a processing system, the authorization request message;
receiving, by the acquirer computer system, an authorization response message in response to the authorization request message, the authorization response message approving or declining the processing of the transaction;
sending, by the acquirer computer system, a clearing message to the processing system;
receiving, by the acquirer computer system, a settlement report from the processing system, wherein the settlement report includes a first set of transactions grouped together based on the first identifier associated with the first transacting entity and a second set of transactions grouped together based on a second identifier associated with a second transacting entity; and
settling, by the acquirer computer system, the first set of transactions with a financial institution computer associated with the first transacting entity.

19. The method of claim 18, wherein the acquirer computer system settles the first set of transactions with the financial institution computer associated with the first transacting entity without further processing the settlement report received from the processing system to identify the transactions associated with the first transacting entity.

20. The method of claim 18, wherein the clearing message and the authorization request message are sent in a signal transmission from the acquirer computer system to the processing system.
